(19) United States
(12) Patent Application Publication
(10) Pub. No.: US 2024/0126508 A1
(43) Pub. Date: Apr. 18, 2024

(54) DEVICE FOR COMPUTING AN INNER PRODUCT

(71) Applicant: National Chung Cheng University, Min-Hsiung (TW)

(72) Inventor: Tay-Jyi LIN, Minhsiung Township (TW)

(21) Appl. No.: 18/074,245

(22) Filed: Dec. 2, 2022

(30) Foreign Application Priority Data
Oct. 18, 2022 (TW) 111139529

(51) Int. Cl. G06F 7/523; G06F 7/50; G06F 7/544

(52) U.S. Cl. CPC G06F 7/523; G06F 7/50; G06F 7/5443

(57) ABSTRACT

A device for computing an inner product includes a data memory, an inverted index memory (IIM), a weight mapping table, a controller, a pre-accumulator, and a multiplier-accumulate (MAC) module. The data memory stores data groups. Each data group includes data values. The IIM stores a data address and a corresponding weight index value of each data group in the data memory. The weight mapping table stores a weight value corresponding to the weight index value. The controller and the IIM drive the data memory to sequentially output the data values of the data groups and drive the mapping table to sequentially output weight values. The pre-accumulator accumulates the data values of each data group to generate accumulation values. The MAC module computes the accumulation and the weight value that correspond to each data group based on a distributive law, thereby generating an inner product value.

This application claims priority of Application No. 111139529 filed in Taiwan on 18 Oct. 2022 under 35 U.S.C. § 119; the entire contents of all of which are hereby incorporated by reference.

### BACKGROUND OF THE INVENTION

### Field of the Invention

The present invention relates to a computing device, particularly to a device for computing an inner product.

### Description of the Related Art

The inner product of vectors is one of the most important cores in signal processing and neural networks. The inner product operations of vectors applied to signal processing and neural networks use a lot of the same weights or coefficients, such as the symmetric coefficients of linear-phase finite impulse response (FIR) filters or the highly quantized weights of neural networks. Since the coefficients of linear-phase FIR are completely symmetrical, two input data with symmetrical coefficients firstly are added based on the mathematical distributive law to generate a sum. Then, the sum is multiplied by the coefficient value in order to effectively reduce multiplication computation amounts by half. However, the same weights or coefficients in neural networks or other general applications appear almost randomly. Thus, the literature so far only stores the weights in an indexed manner, which reduces the complexity of a weight memory for storing and reading data. That is to say, it is assumed that there are K different weights in the inner product computation. Each weight requiring a weight of n bits is represented by an index with log₂K bits, which effectively reduces the number of bits of the weight.

FIG. 1 is a schematic diagram illustrating a fully-connected neural network in the conventional technology. The neural network is composed of many neurons, each one of which is represented as one circle depicted in FIG. 1. The circles from left to right respectively represent neurons of an input layer, neurons of hidden layers, and neurons of an output layer. x_{i,j} represents the j-th neuron of the i-th layer. The j-th neuron x_{i,j} of the i-th layer needs to compute the inner product of the output data of the k-th neuron x_{i-1,k} of the (i−1)-th layer and the corresponding weight data w_{i,j,k} and adds a bias b_{i,j} corresponding to the j-th neuron of the i-th layer to obtain a result. The result is then processed by an activation function and described as follows: x_{i,j}=max[Σₖ₌₀^{N}^{_{i−1}}⁻¹w_{i,j,k}·x_{i-1,k}+k=0 b_{i,j}, 0]. Nᵢ₋₁ represents the number of input data corresponding to neurons of the (i−1)-th layer. The inner product computation of vectors is directly implemented based on a multiplier-accumulator (MAC). The MAC multiplies elements corresponding to two vectors (e.g., the output data of all neurons of a previous layer of the neural network and the corresponding weight data) to obtain products and sequentially accumulates the products to generate an inner product. FIG. 2 is a schematic diagram illustrating a device for computing an inner product applied to the neural network in the conventional technology. As illustrated in FIG. 2, the device for computing an inner product includes a microinstruction generator 10, a data buffer 12, a weight memory 14, a multiplier 16, an adder 18, and an activation function processor 20. The operation steps in FIG. 2 are briefly described as follows: 1. placing input data in the data buffer 12; 2. sequentially reading the input data in the data buffer 12 and the corresponding weight coefficients, calculating their inner product, adding a bias to the inner product, performing an activation function on the inner product plus the bias to generate a computation result, and storing the computation result to the data buffer 12 by the neuron; 3. repeating the neuron computing step of Step 2 until the computation of all neurons in the first hidden layer is completed, and storing the result to the data buffer 12; 4. sequentially reading the outputs of the first hidden layer in the data buffer 12 and the corresponding weight coefficients, calculating their inner product, adding a bias to the inner product, performing an activation function on the inner product plus the bias to generate a computation result, and storing the computation result to the data buffer 12 by the neuron; 5. repeating the neuron computing step of Step 4 until the computation of all neurons in the second hidden layer is completed, and storing the result to the data buffer 12; 6. repeating Step 5 until the computation of all steps is completed; 7. sequentially reading the outputs of the last hidden layer in the data buffer 12 and the corresponding weight coefficients, calculating their inner product, adding a bias to the inner product, and storing the inner product plus the bias to the data buffer 12; and 8. repeating the output computing step of Step 7 until the computation of the output layer is completed and storing the result to the data buffer 12.

FIG. 3 is a schematic diagram illustrating a device for computing an inner product in the conventional technology. The device for computing an inner product includes a microinstruction 10, a data buffer 12, a multiplier 16, an adder 18, an activation function processor 20, an index memory 22, and a weight mapping table 24. FIG. 3 uses the index memory 22 and the weight mapping table 24. However, FIG. 3 does not make full use of the characteristics of the same coefficients and the mathematical distributive law to reduce the complexity of multiplication computation, which is a pity.

FIG. 4 is a schematic diagram illustrating another device for computing an inner product in the conventional technology. FIG. 4 illustrates the architecture should be easily implemented by those in the art. The device for computing an inner product includes a microinstruction generator 26, a data buffer 28, an index memory 30, a weight mapping table 32, an adder 34, an array 36 of pre-accumulation registers, a multiplier 38, an adder 40, and an activation function processor 42. The array 36 of pre-accumulation registers includes K different pre-accumulators. According to each index value (e.g., 0˜K−1), the K different pre-accumulators respectively accumulate the corresponding input values. After all the input values are accumulated by the corresponding pre-accumulators to generate accumulation values according to the corresponding index values, the accumulation values are multiplied by the corresponding coefficients and finally accumulated to compute an inner product of vectors. In other words, the inner product computation of N elements requires N multiplications and N−1 additions.

According to the mathematical distribution law, the redundant N−K multiplications caused by the same coefficients can be completely eliminated. Although this architecture is intuitive, it requires many pre-accumulators. For K=16, a hidden layer of 512 neurons and a 16-bit operation, 16 pre-accumulators of 25 bits are required. The area of the pre-accumulators is possibly more than that of 16-bit multipliers. The pre-accumulators also consume considerable access power.

To overcome the abovementioned problems, the present invention provides a device for computing an inner product, so as to solve the afore-mentioned problems of the prior art.

### SUMMARY OF THE INVENTION

The present invention provides a device for computing an inner product, which achieves high efficiency and low power consumption.

In an embodiment of the present invention, a device for computing an inner product is provided. The device for computing an inner product includes a data memory, an inverted index memory (IIM), a weight mapping table, a controller, a pre-accumulator, and a multiplier-accumulate (MAC) module. The data memory is configured to store a plurality of data groups, wherein each of the plurality of data groups comprises data values. The IIM is configured to store a data address and a corresponding weight index value of each of the plurality of data groups in the data memory. The weight mapping table is configured to store a weight value corresponding to the weight index value. The controller is electrically connected to the data memory, the IIM, and the weight mapping table. The controller is configured to sequentially obtain the data addresses and the corresponding weight index values of the plurality of data groups from the IIM, thereby driving the data memory to sequentially output the data values of the plurality of data groups and driving the weight mapping table to sequentially output the weight values corresponding to the weight index values. The pre-accumulator is electrically connected to the data memory. The pre-accumulator is configured to receive and accumulate the data values of each of the plurality of data groups to generate accumulation values. The MAC module is electrically connected to the pre-accumulator and the weight mapping table. The MAC module is configured to receive the accumulation value and the weight value that correspond to each of the plurality of data groups. The MAC module is configured to perform multiplication and accumulation on the accumulation value and the weight value that correspond to each of the plurality of data groups based on the distributive law, thereby generating an inner product value.

In an embodiment of the present invention, the IIM is configured to store the data address and the corresponding weight index value of each of the plurality of data groups based on variable length coding.

In an embodiment of the present invention, the weight values corresponding to the plurality of data groups include positive values and negative values. The IIM is configured to store the corresponding data addresses in an order of from the positive values to the negative values.

In an embodiment of the present invention, the IIM is configured to store the corresponding data addresses in an order of from the smallest negative value to the largest negative value. The data address corresponding to the smallest negative value is closer to the data address corresponding to the positive value than the data address corresponding to the largest negative value.

In an embodiment of the present invention, the MAC module includes a multiplier and an accumulator. The multiplier is electrically connected to the pre-accumulator and the weight mapping table. The multiplier is configured to receive and multiply the accumulation value and the weight value that correspond to each of the plurality of data groups, thereby generating product values. The accumulator is electrically connected to the multiplier and configured to receive and accumulate the product values, thereby generating the inner product value.

In an embodiment of the present invention, the accumulator is further electrically connected to a function processor. The function processor is configured to perform an activation function, a rounding function, or a saturation function on the inner product value.

In an embodiment of the present invention, the inner product value is applied to a neural network, a filter, or a related computation.

In an embodiment of the present invention, a device for computing an inner product includes a data memory, an inverted index memory (IIM), a controller, a pre-accumulator, and a multiplier-accumulate (MAC) module. The data memory is configured to store a plurality of data groups, wherein each of the plurality of data groups comprises data values. The IIM is configured to store a data address and a corresponding weight value of each of the plurality of data groups in the data memory. The controller is electrically connected to the data memory and the IIM. The controller is configured to sequentially obtain the data addresses and the corresponding weight values of the plurality of data groups from the IIM, thereby driving the data memory to sequentially output the data values of the plurality of data groups and to sequentially output the weight values corresponding to the plurality of data groups. The pre-accumulator is electrically connected to the data memory. The pre-accumulator is configured to receive and accumulate the data values of each of the plurality of data groups to generate accumulation values. The MAC module is electrically connected to the pre-accumulator and the controller. The MAC module is configured to receive the accumulation value and the weight value that correspond to each of the plurality of data groups. The MAC module is configured to perform multiplication and accumulation on the accumulation value and the weight value that correspond to each of the plurality of data groups based on the distributive law, thereby generating an inner product value.

In an embodiment of the present invention, the IIM is configured to store the data address and the corresponding weight value of each of the plurality of data groups based on variable length coding.

In an embodiment of the present invention, the weight values corresponding to the plurality of data groups comprise positive values and negative values. The IIM is configured to store corresponding the data addresses in an order of from the positive values to the negative values.

In an embodiment of the present invention, the IIM is configured to store the corresponding data addresses in an order of from the smallest negative value to the largest negative value. The data address corresponding to the smallest negative value is closer to the data address corresponding to the positive value than the data address corresponding to the largest negative value.

In an embodiment of the present invention, the MAC module includes a multiplier and an accumulator. The multiplier is electrically connected to the pre-accumulator and the controller. The multiplier is configured to receive and multiply the accumulation value and the weight value that correspond to each of the plurality of data groups, thereby generating product values. The accumulator is electrically connected to the multiplier and configured to receive and accumulate the product values, thereby generating the inner product value.

In an embodiment of the present invention, the accumulator is further electrically connected to a function processor. The function processor is configured to perform an activation function, a rounding function, or a saturation function on the inner product value.

In an embodiment of the present invention, the inner product value is applied to a neural network, a filter, or a related computation.

To sum up, the device for computing an inner product obtains the data address and the corresponding weight index value of each data group in the data memory, employs a single pre-accumulator to accumulate all the data values of each data group according to the data address and the corresponding weight index value, and reduces the amount of multiplication computation of the same weight values based on the mathematical distributive law, thereby achieving high efficiency and lower power consumption.

Below, the embodiments are described in detail in cooperation with the drawings to make easily understood the technical contents, characteristics and accomplishments of the present invention.

### BRIEF DESCRIPTION OF THE DRAWINGS

FIG. 1 is a schematic diagram illustrating a fully-connected neural network in the conventional technology;

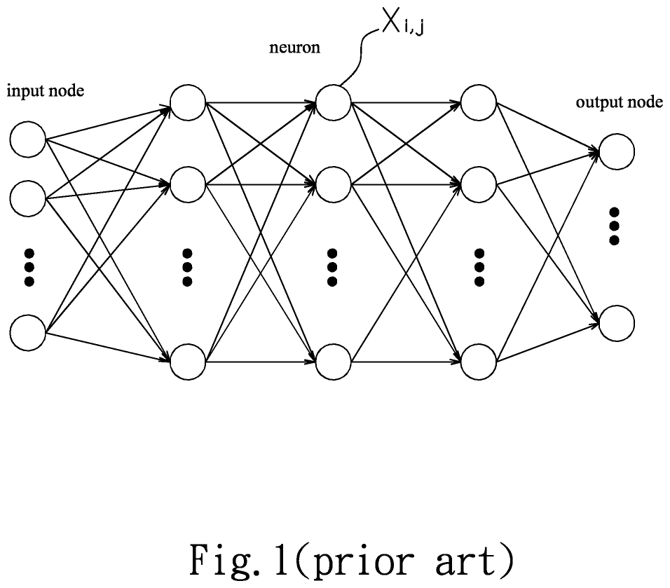

FIG. 2 is a schematic diagram illustrating a device for computing an inner product applied to the neural network of FIG. 1 in the conventional technology;

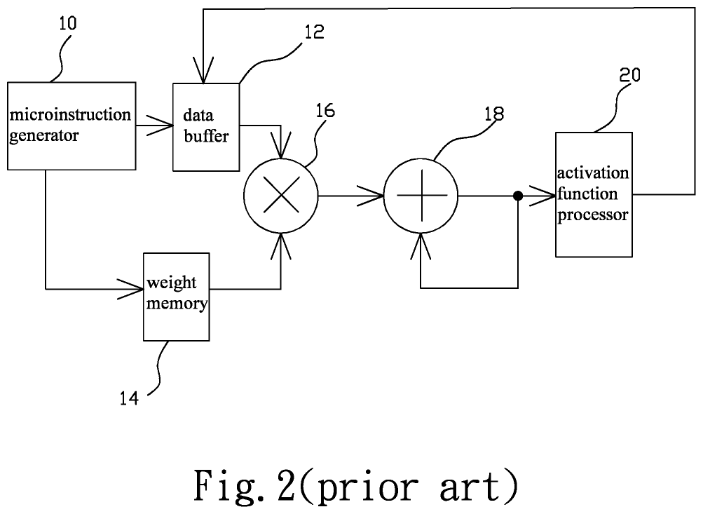

FIG. 3 is a schematic diagram illustrating a device for computing an inner product in the conventional technology;

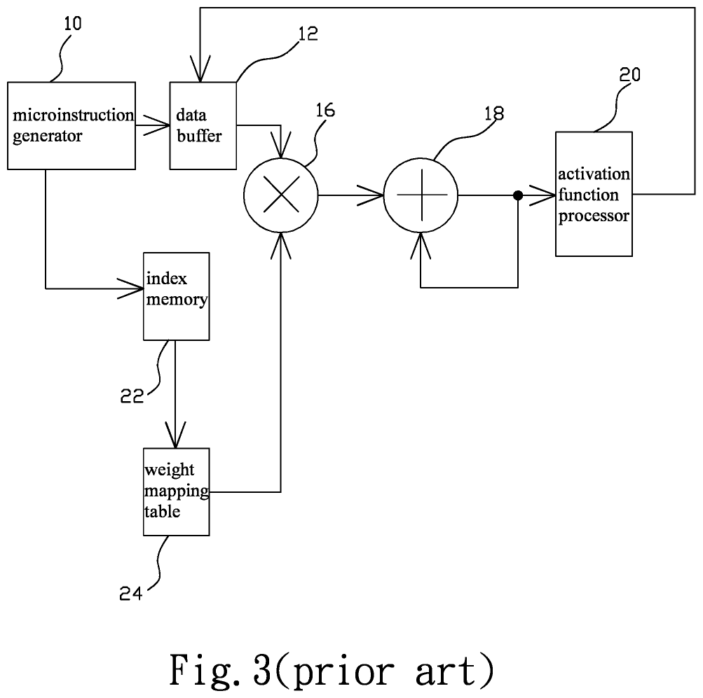

FIG. 4 is a schematic diagram illustrating another device for computing an inner product in the conventional technology;

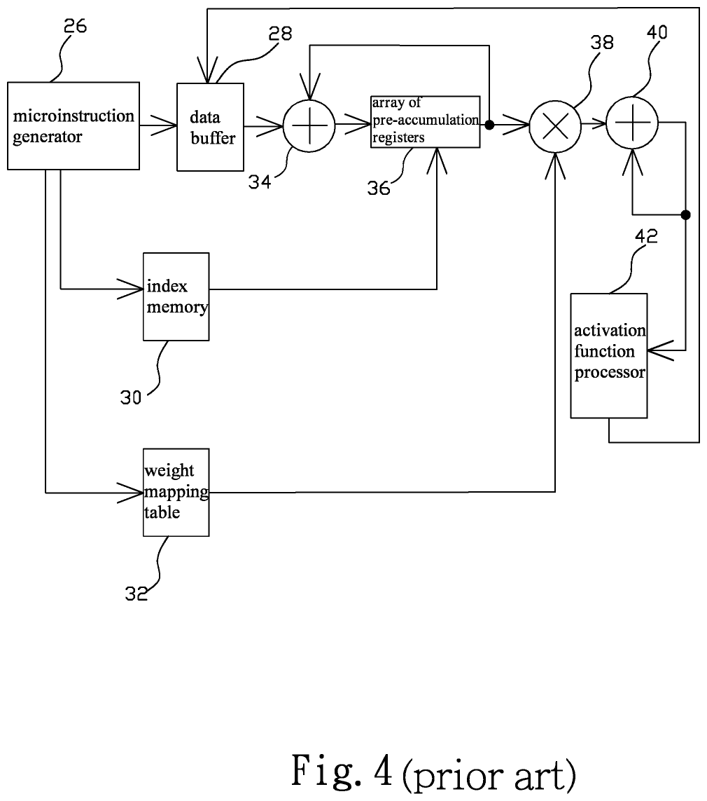

FIG. 5 is a schematic diagram illustrating a device for computing an inner product according to a first embodiment of the present invention;

FIG. 6 is a schematic diagram illustrating weight values, biases, data addresses, weight index values, and the number of data values stored in an inverted index memory (TIM) according to an embodiment of the present invention; and

FIG. 7 is a schematic diagram illustrating a device for computing an inner product according to a second embodiment of the present invention.

### DETAILED DESCRIPTION OF THE INVENTION

Reference will now be made in detail to embodiments illustrated in the accompanying drawings. Wherever possible, the same reference numbers are used in the drawings and the description to refer to the same or like parts. In the drawings, the shape and thickness may be exaggerated for clarity and convenience. This description will be directed in particular to elements forming part of, or cooperating more directly with, methods and apparatus in accordance with the present disclosure. It is to be understood that elements not specifically shown or described may take various forms well known to those skilled in the art. Many alternatives and modifications will be apparent to those skilled in the art, once informed by the present disclosure.

When an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The invention is particularly described with the following examples which are only for instance. Those skilled in the art will readily observe that numerous modifications and alterations of the device and method may be made while retaining the teachings of the invention. Accordingly, the following disclosure should be construed as limited only by the metes and bounds of the appended claims. In the whole patent application and the claims, except for clearly described content, the meaning of the articles “a” and “the” includes the meaning of “one or at least one” of the elements or components. Moreover, in the whole patent application and the claims, except that the plurality can be excluded obviously according to the context, the singular articles also contain the description for the plurality of elements or components. In the entire specification and claims, unless the contents clearly specify the meaning of some terms, the meaning of the article “wherein” includes the meaning of the articles “wherein” and “whereon”. The meanings of every term used in the present claims and specification refer to a usual meaning known to one skilled in the art unless the meaning is additionally annotated. Some terms used to describe the invention will be discussed to guide practitioners about the invention. The examples in the present specification do not limit the claimed scope of the invention.

Further, in the present specification and claims, the term “comprising” is open type and should not be viewed as the term “consisted of” In addition, the term “electrically coupled” can be referring to either directly connecting or indirectly connecting between elements. Thus, if it is described in the below contents of the present invention that a first device is electrically coupled to a second device, the first device can be directly connected to the second device, or indirectly connected to the second device through other devices or means. Moreover, when the transmissions or generations of electrical signals are mentioned, one skilled in the art should understand some degradations or undesirable transformations could be generated during the operations. If it is not specified in the specification, an electrical signal at the transmitting end should be viewed as substantially the same signal as that at the receiving end. For example, when the end A of an electrical circuit provides an electrical signal S to the end B of the electrical circuit, the voltage of the electrical signal S may drop due to passing through the source and drain of a transistor or due to some parasitic capacitance. However, the transistor is not deliberately used to generate the effect of degrading the signal to achieve some result, that is, the signal S at the end A should be viewed as substantially the same as that at the end B.

Unless otherwise specified, some conditional sentences or words, such as “can”, “could”, “might”, or “may”, usually attempt to express what the embodiment in the present invention has, but it can also be interpreted as a feature, element, or step that may not be needed. In other embodiments, these features, elements, or steps may not be required.

Furthermore, it can be understood that the terms “comprising,” “including,” “having,” “containing,” and “involving” are open-ended terms, which refer to “may include but is not limited to so.” Besides, each of the embodiments or claims of the present invention is not necessary to achieve all the effects and advantages possibly to be generated, and the abstract and title of the present invention is used to assist for patent search and is not used to further limit the claimed scope of the present invention.

In the following description, a device for computing an inner product will be described. The device for computing an inner product obtains a data address and a corresponding weight index value of each data group in a data memory, employs a single pre-accumulator to accumulate all the data values of each data group according to the data address and the corresponding weight index value, and reduces the amount of multiplication computation of the same weight values based on the mathematical distributive law, thereby achieving high efficiency and lower power consumption.

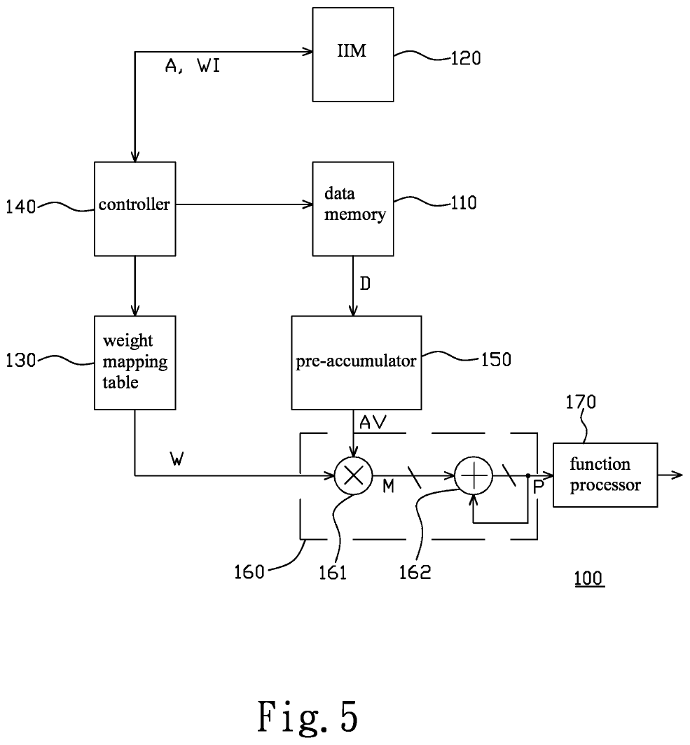

FIG. 5 is a schematic diagram illustrating a device for computing an inner product according to a first embodiment of the present invention. Referring to FIG. 5, a first embodiment of a device 100 for computing an inner product is introduced as follows. The device 100 for computing an inner product includes a data memory 110, an inverted index memory (IIM) 120, a weight mapping table 130, a controller 140, a pre-accumulator 150, and a multiplier-accumulate (MAC) module 160. The data memory 110 may be, but not limited to, a register. The controller 140 is electrically connected to the data memory 110, the IIM 120, and the weight mapping table 130. The pre-accumulator 150 is electrically connected to the data memory 110. The MAC module 160 is electrically connected to the pre-accumulator 150 and the weight mapping table 130.

The data memory 110 stores a plurality of data groups, wherein each of the plurality of data groups includes data values D. The IIM 120 stores a data address A and a corresponding weight index value WI of each data group in the data memory 110. The weight mapping table 130 stores a weight value W corresponding to the weight index value WI. The weight index value WI and the corresponding weight value W may be the same values, but the present invention is not limited thereto. The controller 140 sequentially obtains the data addresses A and the corresponding weight index values WI of the data groups from the IIM 120, thereby driving the data memory 110 to sequentially output the data values D of the data groups and driving the weight mapping table 130 to sequentially output the weight values W corresponding to the weight index values WI. The pre-accumulator 150 receives and accumulates the data values D of each data group to generate accumulation values AV. The MAC module 160 receives the accumulation value AV and the weight value W that correspond to each data group and performs multiplication and accumulation on the accumulation value AV and the weight value W that correspond to each data group based on the distributive law, thereby generating an inner product value P. The mathematical distributive law can reduce the amount of multiplication computation of the same weight values to achieve high efficiency and low power consumption.

Assume that the data groups include a first data group and a second data group. The first data group includes first data values D1. The second data group includes second data values D2. The data memory 110 stores the first data address A1 and the corresponding first weight index value WI1 of the first data group and the second data address A2 and the corresponding second weight index value WI2 of the second data group. The first weight index value WI1 and the second weight index value WI2 respectively correspond to the first weight value W1 and the second weight value W2. The accumulation values AV include a first accumulation value AV1 and a second accumulation value AV2. Firstly, the controller 140 obtains the first data address A1 and the corresponding first weight index value WI1 of the first data group from the IIM 120, thereby driving the data memory 110 to output the first data value D1 of the first data group and driving the weight mapping table 130 to output the first weight value W1 corresponding to the first weight index value W11. The pre-accumulator 150 receives and accumulates the first data values D1 of the first data group to generate a first accumulation value AV1. Then, the controller 140 obtains the second data address A2 and the corresponding second weight index value WI2 of the second data group from the IIM 120, thereby driving the data memory 110 to output the second data value D2 of the second data group and driving the weight mapping table 130 to output the second weight value W2 corresponding to the second weight index value WI2. The pre-accumulator 150 receives and accumulates the second data values D2 of the second data group to generate a second accumulation value AV2. According equation (1), the MAC module 160 computes the first accumulation value AV1, the second accumulation value AV2, the first weight value W1, and the second weight value W2 to obtain the inner product P.

AV1×W1+AV2×W2=P (1)

In some embodiments of the present invention, the MAC module 160 may include a multiplier 161 and an accumulator 162. The multiplier 161 is electrically connected to the pre-accumulator 150 and the weight mapping table 130. The accumulator 162 is electrically connected to the multiplier 161. The multiplier 161 receives and multiplies the accumulation value AV and the weight value W that correspond to each data group, thereby generating product values M. The accumulator 162 receives and accumulates the product values M, thereby generating the inner product value P.

In an embodiment of the present invention, the inner product value P can be applied to a neural network. The accumulator 162 may be electrically connected to a function processor 170. The function processor 170 performs an activation function, a rounding function, and a saturation function on the inner product value P. For example, the activation function may be a rectified linear unit (ReLU) function, but the present invention is not limited thereto. In another embodiment, the inner product value P is alternatively applied to a filter, a related computation, or the like. The weight values W corresponding to the data groups include positive values and negative values. When the activation function is a ReLU function, the IIM 120 stores the corresponding data addresses A in an order of from the positive values to the negative values. In addition, the IIM 120 stores the corresponding data addresses A in an order of from the smallest negative value to the largest negative value. The data address A corresponding to the smallest negative value is closer to the data address A corresponding to the positive value than the data address A corresponding to the largest negative value. As a result, the MAC module 160 sequentially computes the data corresponding to the positive weight value W and the data corresponding to the negative weight value W. When computing the data corresponding to the negative weight values W, the MAC module 160 computes the data corresponding to the negative weight values W in an order of from the smallest negative weight value W to the largest negative weight value W. When the polarity of the computation result of the accumulator 162 changes from positive to negative, the inner product value P is regarded as 0 and the computation is terminated prematurely.

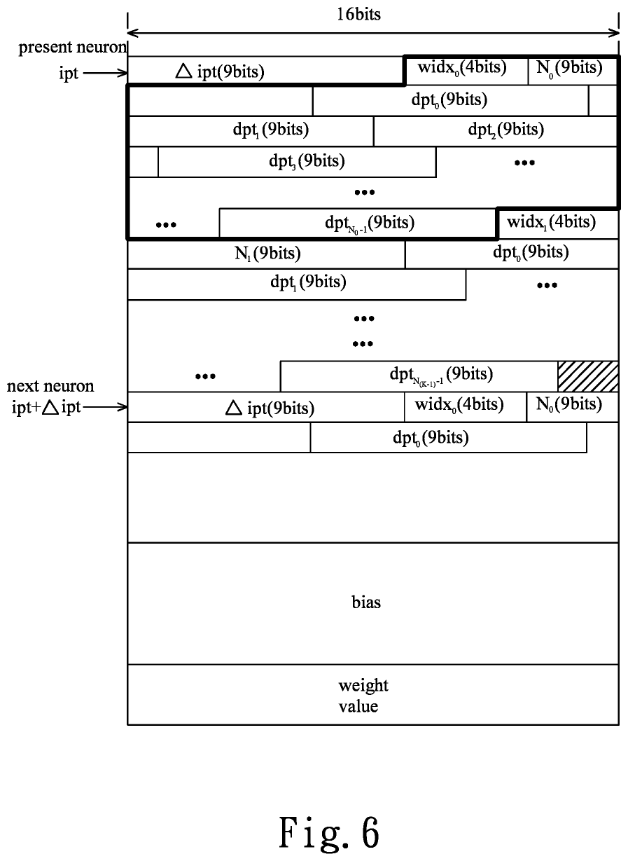

FIG. 6 is a schematic diagram illustrating weight values, biases, data addresses, weight index values, and the number of data values stored in an inverted index memory (TIM) according to an embodiment of the present invention. Referring to FIG. 6 and FIG. 5, the IIM 120 may store the data address A and the corresponding weight index value WI of each data group based on variable length coding. FIG. 6 is applied to a full-connected neural network for voice conversion, which includes 129 input nodes, three hidden layers with 512 neurons, and 129 output nodes. In FIG. 6, the number of the weight values is K and the precision of data is 16 bits. In order to prematurely terminate the computation, each neuron and each parameter related to output computation are aligned to a new halfword (with 16 bits). In other words, if each neuron or each output parameter is not a multiple of 16 bits, fragments will be generated, as shown by the slashes. ipt represents the address of the present neuron in the IIM 120. ipt+Δipt represents the address of the next neuron in the IIM 120. Δipt represents the offset of the address of the neuron in the IIM 120, wherein the offset has 9 bits and a unit of a halfword with fragments. The offset is used to compute the initial address of the parameter of the next neuron. The offset is convenient to quickly start the computation of the next neuron when the computation is terminated prematurely. widx₀ and widx₁ represent the weight index values. Since K=16, the length of the weight index value is 4 bits. N₀ and N₁ respectively represent the numbers of the data values of the data groups corresponding to widx₀ and widx₁. The length of each of N₀ and N₁ is 9 bits. dpt₀, dpt₁, dpt₂, dpt₃, dpt_{N}_{_{0−1}}, and dpt_{N}_{_{(K−1)}}₋₁ respectively represent the data addresses A of the data values. Since the hidden layer has 512 neurons, each data address has a length of 9 bits. In addition, according to requirements, the IIM 120 may store the weights values and biases. The bold box represents the encoding of all the data addresses A corresponding to the single weight index value WI, which is dynamically aligned and decoded by the controller 140. The present invention is not limited to the encoding, arrangement, and length of each data and the data width of the IIM 120.

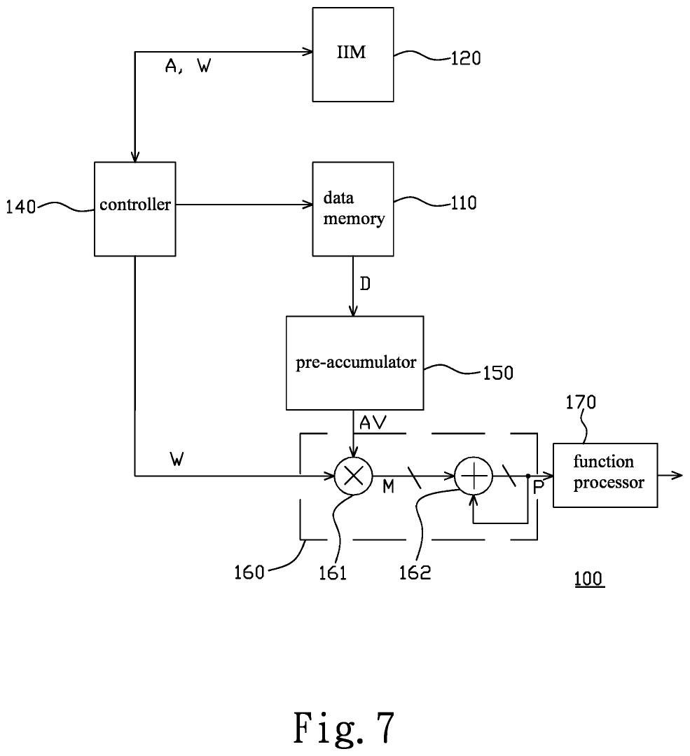

In order to save the area of the chip, the weight mapping table 130 can be integrated in the IIM 120. FIG. 7 is a schematic diagram illustrating a device for computing an inner product according to a second embodiment of the present invention. Referring to FIG. 7, a second embodiment of the device for computing an inner product of the present invention is introduced as follows. The device for computing an inner product includes a data memory 110, an IIM 120, a controller 140, a pre-accumulator 150, and a MAC module 160. The data memory 110 may be, but not limited to, a register. The controller 140 is electrically connected to the data memory 110 and the IIM 120. The pre-accumulator 150 is electrically connected to the data memory 110. The MAC module 160 is electrically connected to the pre-accumulator 150 and the controller 140.

The data memory 110 stores a plurality of data groups, wherein each of the plurality of data groups includes data values D. The IIM 120 stores a data address A and a corresponding weight index value WI of each data group in the data memory 110. The controller 140 sequentially obtains the data addresses A and the corresponding weight values W of the data groups from the IIM 120, thereby driving the data memory 110 to sequentially output the data values D of the data groups and sequentially output the weight values W corresponding to the data groups. The pre-accumulator 150 receives and accumulates the data values D of each data group to generate accumulation values AV. The MAC module 160 receives the accumulation value AV and the weight value W that correspond to each data group and performs multiplication and accumulation on the accumulation value AV and the weight value W that correspond to each data group based on the distributive law, thereby generating an inner product value P.

Assume that the data groups include a first data group and a second data group. The first data group includes first data values D1. The second data group includes second data values D2. The data memory 110 stores the first data address A1 and the corresponding first weight value W1 of the first data group and the second data address A2 and the corresponding second weight value W2 of the second data group. The accumulation values AV include a first accumulation value AV1 and a second accumulation value AV2. Firstly, the controller 140 obtains the first data address A1 and the corresponding first weight value W1 of the first data group from the IIM 120, thereby driving the data memory 110 to output the first data value D1 of the first data group and the first weight value W1. The pre-accumulator 150 receives and accumulates the first data values D1 of the first data group to generate a first accumulation value AV1. Then, the controller 140 obtains the second data address A2 and the corresponding second weight value W2 of the second data group from the IIM 120, thereby driving the data memory 110 to output the second data value D2 of the second data group and the second weight value W2. The pre-accumulator 150 receives and accumulates the second data values D2 of the second data group to generate a second accumulation value AV2. According equation (1), the MAC module 160 computes the first accumulation value AV1, the second accumulation value AV2, the first weight value W1, and the second weight value W2 to obtain the inner product P.

The MAC module 160 may include a multiplier 161 and an accumulator 162. The multiplier 161 is electrically connected to the pre-accumulator 150 and the controller 140. The accumulator 162 is electrically connected to the multiplier 161. The multiplier 161 receives and multiplies the accumulation value AV and the weight value W that correspond to each data group, thereby generating product values M. The accumulator 162 receives and accumulates the product values M, thereby generating the inner product value P.

The accumulator 162 of the second embodiment may be also electrically connected to a function processor 170. The function processor 170 performs an activation function, a rounding function, and a saturation function on the inner product value P. For example, the activation function may be a rectified linear unit (ReLU) function, but the present invention is not limited thereto. In another embodiment, the inner product value P is alternatively applied to a filter, a related computation, or the like. The weight values W corresponding to the data groups include positive values and negative values. When the activation function is a ReLU function, the IIM 120 stores the corresponding data addresses A in an order of from the positive values to the negative values. In addition, the IIM 120 stores the corresponding data addresses A in an order of from the smallest negative value to the largest negative value. The data address A corresponding to the smallest negative value is closer to the data address A corresponding to the positive value than the data address A corresponding to the largest negative value. As a result, the MAC module 160 sequentially computes the data corresponding to the positive weight value W and the data corresponding to the negative weight value W. When computing the data corresponding to the negative weight values W, the MAC module 160 computes the data corresponding to the negative weight values W in an order of from the smallest negative weight value W to the largest negative weight value W. When the polarity of the computation result of the accumulator 162 changes from positive to negative, the inner product value P is regarded as 0 and the computation is terminated prematurely.

As illustrated in FIG. 7 and FIG. 6, the IIM 120 may store the data address A and the corresponding weight value W of each data group based on variable length coding.

According to the embodiments provided above, the device for computing an inner product obtains the data address and the corresponding weight index value of each data group in the data memory, employs a single pre-accumulator to accumulate all the data values of each data group according to the data address and the corresponding weight index value, and reduces the amount of multiplication computation of the same weight values based on the mathematical distributive law, thereby achieving high efficiency and lower power consumption.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A device for computing an inner product comprising:
a data memory configured to store a plurality of data groups, wherein each of the plurality of data groups comprises data values;
an inverted index memory (IIM) configured to store a data address and a corresponding weight index value of each of the plurality of data groups in the data memory;
a weight mapping table configured to store a weight value corresponding to the weight index value;
a controller electrically connected to the data memory, the IIM, and the weight mapping table, wherein the controller is configured to sequentially obtain the data addresses and the corresponding weight index values of the plurality of data groups from the IIM, thereby driving the data memory to sequentially output the data values of the plurality of data groups and driving the weight mapping table to sequentially output the weight values corresponding to the weight index values;
a pre-accumulator electrically connected to the data memory, wherein the pre-accumulator is configured to receive and accumulate the data values of each of the plurality of data groups to generate accumulation values; and
a multiplier-accumulate (MAC) module electrically connected to the pre-accumulator and the weight mapping table, wherein the MAC module is configured to receive the accumulation value and the weight value that correspond to each of the plurality of data groups, and configured to perform multiplication and accumulation on the accumulation value and the weight value that correspond to each of the plurality of data groups based on a distributive law, thereby generating an inner product value.

2. The device for computing an inner product according to claim 1, wherein the IIM is configured to store the data address and the corresponding weight index value of each of the plurality of data groups based on variable length coding.

3. The device for computing an inner product according to claim 1, wherein the weight values corresponding to the plurality of data groups comprise positive values and negative values, and the IIM is configured to store corresponding the data addresses in an order of from the positive values to the negative values.

4. The device for computing an inner product according to claim 3, wherein the IIM is configured to store corresponding the data addresses in an order of from a smallest the negative value to a largest the negative value, and the data address corresponding to the smallest the negative value is closer to the data address corresponding to the positive value than the data address corresponding to the largest the negative value.

5. The device for computing an inner product according to claim 1, wherein the MAC module includes:
a multiplier electrically connected to the pre-accumulator and the weight mapping table, wherein the multiplier is configured to receive and multiply the accumulation value and the weight value that correspond to each of the plurality of data groups, thereby generating product values; and
an accumulator electrically connected to the multiplier and configured to receive and accumulate the product values, thereby generating the inner product value.

6. The device for computing an inner product according to claim 5, wherein the accumulator is further electrically connected to a function processor, and the function processor is configured to perform an activation function, a rounding function, or a saturation function on the inner product value.

7. The device for computing an inner product according to claim 1, wherein the inner product value is applied to a neural network, a filter, or a related computation.

8. A device for computing an inner product comprising:
a data memory configured to store a plurality of data groups, wherein each of the plurality of data groups comprises data values;
an inverted index memory (IIM) configured to store a data address and a corresponding weight value of each of the plurality of data groups in the data memory;
a controller electrically connected to the data memory and the IIM, wherein the controller is configured to sequentially obtain the data addresses and the corresponding weight values of the plurality of data groups from the IIM, thereby driving the data memory to sequentially output the data values of the plurality of data groups and to sequentially output the weight values corresponding to the plurality of data groups;
a pre-accumulator electrically connected to the data memory, wherein the pre-accumulator is configured to receive and accumulate the data values of each of the plurality of data groups to generate accumulation values; and
a multiplier-accumulate (MAC) module electrically connected to the pre-accumulator and the controller, wherein the MAC module is configured to receive the accumulation value and the weight value that correspond to each of the plurality of data groups, and configured to perform multiplication and accumulation on the accumulation value and the weight value that correspond to each of the plurality of data groups based on a distributive law, thereby generating an inner product value.

9. The device for computing an inner product according to claim 8, wherein the IIM is configured to store the data address and the corresponding weight value of each of the plurality of data groups based on variable length coding.

10. The device for computing an inner product according to claim 8, wherein the weight values corresponding to the plurality of data groups comprise positive values and negative values, and the IIM is configured to store corresponding the data addresses in an order of from the positive values to the negative values.

11. The device for computing an inner product according to claim 10, wherein the IIM is configured to store corresponding the data addresses in an order of from a smallest the negative value to a largest the negative value, and the data address corresponding to the smallest the negative value is closer to the data address corresponding to the positive value than the data address corresponding to the largest the negative value.

12. The device for computing an inner product according to claim 8, wherein the MAC module includes:
a multiplier electrically connected to the pre-accumulator and the controller, wherein the multiplier is configured to receive and multiply the accumulation value and the weight value that correspond to each of the plurality of data groups, thereby generating product values; and
an accumulator electrically connected to the multiplier and configured to receive and accumulate the product values, thereby generating the inner product value.

13. The device for computing an inner product according to claim 12, wherein the accumulator is further electrically connected to a function processor, and the function processor is configured to perform an activation function, a rounding function, or a saturation function on the inner product value.

14. The device for computing an inner product according to claim 8, wherein the inner product value is applied to a neural network, a filter, or a related computation.
